(19) United States
(12) Patent Application Publication
(10) Pub. No.: US 2013/0120240 A1
(43) Pub. Date: May 16, 2013

(54) APPARATUS AND METHOD FOR CONTROLLING IMAGE DISPLAY DEPENDING ON MOVEMENT OF TERMINAL

(71) Applicant: Samsung Electronics Co., Ltd., Gyeonggi-do (KR)

(72) Inventor: Hyun-Su HONG, Gyeonggi-do (KR)

(73) Assignee: Samsung Electronics Co., Ltd., Gyeonggi-do (KR)

(21) Appl. No.: 13/674,400

(22) Filed: Nov. 12, 2012

(30) Foreign Application Priority Data
Nov. 10, 2011 (KR) 10-2011-0117000

(51) Int. Cl. G06F 3/03

(52) U.S. Cl. CPC G06F 3/03
USPC 345/156

(57) ABSTRACT

A method for controlling image display based on movement of a terminal is provided. The method includes displaying any one image in an image list, when an image view feature runs; detecting movement of the terminal; and sequentially replacing and outputting images in the image list based on at least one of a moving direction and a moving angle of the terminal, upon detecting the movement of the terminal.

### PRIORITY

This application claims priority under 35 U.S.C. §119(a) to a Korean Patent Application filed in the Korean Intellectual Property Office on Nov. 10, 2011 and assigned Serial No. 10-2011-0117000, the entire disclosure of which is incorporated herein by reference.

### BACKGROUND OF THE INVENTION

1. Field of the Invention

The present invention relates generally to an apparatus and method for controlling image playback, and more particularly, to an apparatus and method capable of controlling image playback depending on movement of a terminal.

2. Description of the Related Art

Due to the recent development of communication technology, the functionality of mobile terminals has been expanded. As a result, a variety of User Interfaces (Uls) with various functions have been provided. Mobile terminals provide a variety of input methods for controlling such various functions.

To enjoy various functions on a general mobile terminal, a user controls the functions by inputting or pressing keys on the mobile terminal. If a mobile terminal is equipped with a touchscreen, the user controls the mobile terminal by touching a specific area on the touchscreen.

For example, in order to view a next photo while viewing photos stored in a photo folder on the mobile terminal, the user must push a directional key button or touch a next photo icon. In this way, the user controls the mobile terminal by directly manipulating specific input means for controlling the mobile terminal.

As described above, to load and view multiple photos successively using a simple scheme which is controlled only by a standardized input scheme for a terminal such as key inputting and touch inputting, the user must press and hold a key button, or repeatedly press the key button. Similarly, the user must touch and hold a specific position, or repeatedly touch the specific position. In order to change a photo loading direction while viewing photos, the user needs to alternately press two different directional key buttons, or needs to change the direction of a touch input every time. Moreover, if there are a lot of consecutively captured photos, the continuous photo view scheme controlled by a key button and/or a touch input has its limitations. For example, even though photos are automatically replaced when the user presses and holds a key, it takes time to distinguish a press (or touch) for loading one photo from a press (or touch) for consecutively loading several photos, making it difficult for the user to dynamically control the photos as desired.

In this way, in order to perform his or her desired operation on a terminal, a user has to use a user interface requiring hardware-pressing/touching actions, such as keypads and touchscreens. If continuous photo viewing could be controlled by the user's intuitive actions, it could improve the user's experience.

### SUMMARY OF THE INVENTION

Accordingly, the present invention has been made to solve the above-stated problems occurring in the prior art, and an aspect of the present invention provides an apparatus and method for controlling functionality of a terminal more flexibly and rapidly.

Another aspect of embodiments of the present invention is to provide an apparatus and method for allowing a user to play images on a terminal simply and easily.

Another aspect of embodiments of the present invention is to provide an apparatus and method for controlling image playback based on movement of a terminal.

In accordance with one aspect of the present invention, an apparatus for controlling image display depending on movement of a terminal is provided. The apparatus includes a storage for storing one or more images; a display for displaying an image in an image list stored in the storage; a sensor unit for detecting movement of the terminal; and a controller for sequentially replacing and outputting images in the image list on the display based on at least one of a moving direction and a moving angle of the terminal, upon detecting movement by the sensor unit.

In accordance with another aspect of the present invention, a method for controlling image display depending on movement of a terminal in the terminal is provided. The method includes displaying any one image in an image list, when an image view feature runs; detecting movement of the terminal; and sequentially replacing and outputting images in the image list based on at least one of a moving direction and a moving angle of the terminal, upon detecting the movement of the terminal.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 is a block diagram illustrating a terminal according to an embodiment of the present invention;

FIG. 2 illustrates changes in movement of a terminal in up/down and left/right directions according to an embodiment of the present invention;

FIG. 3 illustrates changes in tilt of a terminal according to an embodiment of the present invention;

FIG. 4 illustrates a process of outputting images depending on the movement of a terminal according to an embodiment of the present invention;

FIG. 5 illustrates playback of images according to an embodiment of the present invention;

FIG. 6 illustrates a process of outputting images depending on movement of a terminal according to another embodiment of the present invention; and

FIG. 7 illustrates playback of images according to another embodiment of the present invention.

### DETAILED DESCRIPTION OF EMBODIMENTS OF THE PRESENT INVENTION

Embodiments of the present invention will now be described in detail with reference to the accompanying drawings. In the following description, specific details such as the detailed configuration and components are merely provided to assist the overall understanding of embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness. Throughout the drawings, the same drawing reference numerals will be understood to refer to the same elements, features and structures.

The present invention provides a method for allowing a user to play images on a terminal simply and easily. To this end, the present invention includes a process of detecting movement of the terminal when an image view feature is running, determining a loading speed for images to be displayed on a display based on a moving angle and/or a moving direction of the terminal, and sequentially replacing and outputting images on the display depending on the determined loading speed. In this manner, the user may easily control an image loading speed by simply moving the terminal. Additionally, when viewing consecutively captured photos, the user may watch the photos in succession more simply and easily.

An operation of a terminal, in which the above-described functions are implemented, and components thereof will be described with reference to FIG. 1. The terminal corresponds to devices supporting a function that makes it possible to store and view a plurality of images, such as smart phones, mobile phones, tablet Personal Computers (PCs), digital cameras, MP3 players, game consoles, and display devices. When images are displayed on a TV, a remote controller for sending control signals to the TV also corresponds to the terminal.

Referring to FIG. 1, a terminal 100 includes a camera 110, a memory or storage 120, a sensor unit 130, a vibrator 140, a display 150, and a controller 160.

The camera 110 captures external images in a shooting mode. The camera 110 has a continuous shooting function with which a user automatically takes pictures of a specific subject continuously. Therefore, when the camera 110 operates in a continuous shooting mode, photos are automatically taken continuously at predetermined time intervals.

The storage 120 stores images such as photos, and also stores an application program needed to implement functions and operations of an embodiment of the present invention. The storage 120 stores a table in which an image loading speed is mapped to a rate of change in movement (e.g., a moving distance and a tilt angle). The tilt angle may in one of several directions.

The sensor unit 130 includes inertial sensors (such as an accelerometer, a gyroscope, a shock sensor, and a tilt sensor), an altimeter, a gravity sensor, a geomagnetic sensor, and/or a combination thereof. It will be understood by those of ordinary skill in the art that the present invention is not limited thereto, and the sensor unit 130 may include other types of sensors capable of detecting a moving direction and a moving angle of the terminal 100.

Sensing data (e.g., movement information) output from the sensor unit 130 has a direction and a magnitude. For example, the sensor unit 130 for detecting acceleration of the terminal 100 detects acceleration in a direction of each reference axis among one to three reference axes (e.g., x, y and z-axes), and output the detected acceleration information. The reference axes may be axes (e.g., up/down (z-axis), left/right (x-axis) and back/forth (y-axis) directions of the terminal 100), in directions of which the terminal 100 is moved, or axes (e.g., a gravity direction (z-axis) and its vertical directions (x and y-axes)), in directions of which the terminal 100 is moved.

The sensor unit 130 further includes a computation unit (not shown) for computing rotation angle, direction, speed, moving distance, position, trajectory, and the like depending on the movement of the terminal 100 by integrating the detected acceleration, speed, and the like over time, and outputs the calculated information. The computation unit may be included in the controller 160. To calculate the trajectory or to effectively analyze the moving direction, the computation unit includes a frequency filter that stops or passes signals having a specific band, such as the detected acceleration.

When the sensor 130 includes the computation unit, the sensor 130 calculates a moving direction and a moving angle of the terminal 100 and transfers them to the controller 160. However, when the controller includes the computation unit, the moving direction and the moving angle are calculated in the controller 160. As to the moving direction, the terminal 100 may be moved up/down and left/right. Additionally, the terminal 100 may be moved in a (forward) direction of horizontally getting close to its user and in a (back) direction of horizontally getting away from its user. Moreover, a tilt direction, in which the terminal 100 is tilted with respect to a reference axis, is also a moving direction. As for the moving angle of the terminal 100, the angle is calculated based on a direction in which the terminal 100 is tilted, on the assumption that the current angle is 0°.

The vibrator 140 includes a low-vibration motor or a vibration speaker device. In accordance with an embodiment of the present invention, the vibrator 140 outputs vibrations whenever images are sequentially replaced and output on the display 150. In this manner, while watching images, the user may feel that the images are replaced and displayed. By feeling these tactile effects, the user has fun in controlling photo loading.

The display 150 may be implemented with a Liquid Crystal Display (LCD) panel. When this LCD panel is implemented as a touchscreen, the display 150 serves as an input means. The display 150 outputs images such as photos.

The controller 160 determines a loading speed for images to be displayed on the display 150 based on a moving direction and/or a moving angle received from the sensor unit 130 when an image view feature runs by the user, and sequentially replaces and outputs images on the display 150 depending on the determined loading speed.

Specifically, if the user moves or tilts the terminal 100 in a desired direction, images are sequentially replaced and displayed on the display 150 in a previous image direction or a next image direction depending on the moving direction, and in particular, the image loading speed varies based on a rate of change in movement. The term “image loading speed” refers to a speed at which the next image is loaded following the current image, or may refer to a switching time between images. Therefore, the image loading speed is higher, as a time interval between the current image and the next image is shorter. The image loading speed varies depending on the rate of change in movement, which is calculated based on the moving angle. Thus, because the image loading speed varies in proportion to the rate of change in movement, which is calculated depending on the moving angle, the loading speed is higher as the moving angle is greater.

For example, if the user tilts the terminal 100, the images displayed on the display 150 are replaced quickly or slowly based on the tilt level, e.g., the rate of change in the moving angle. However, the previous or next image is displayed whenever a predetermined rate or more of change in the moving angle is detected. Photos are sequentially loaded and displayed at regular intervals if the user continuously tilts the terminal 100 at a predetermined angle or more.

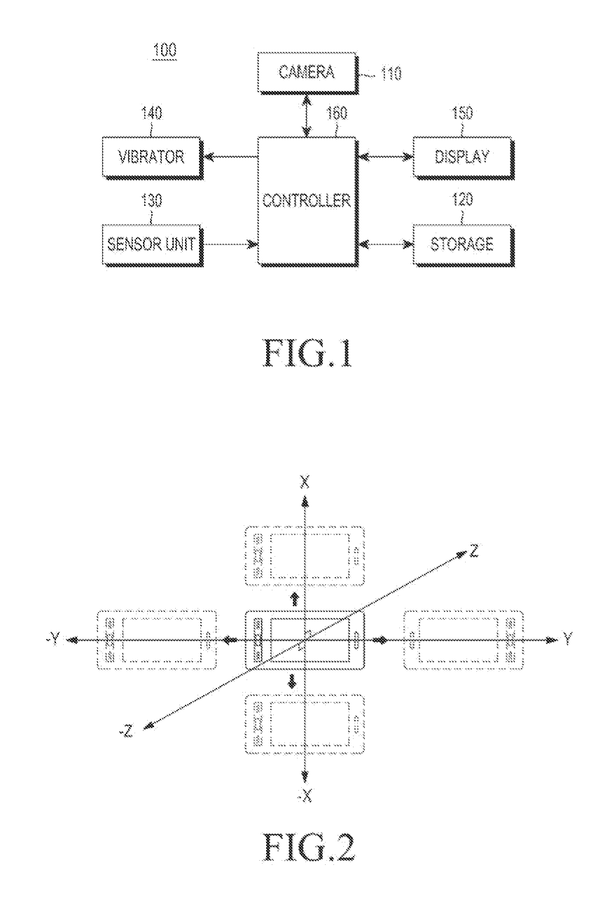

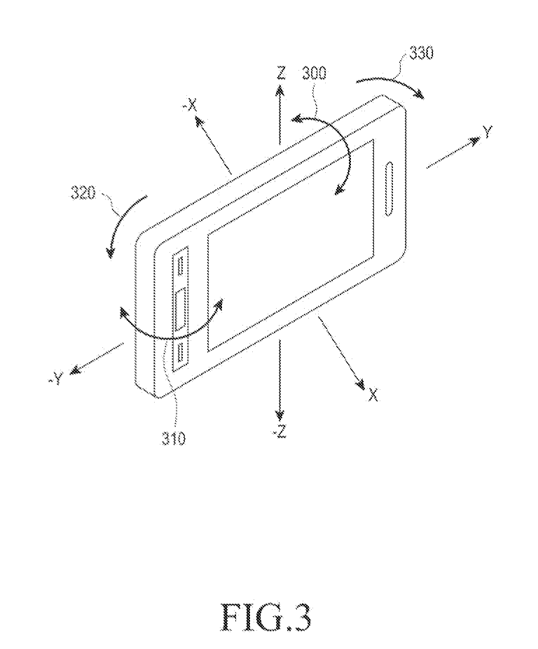

Thus, images are sequentially loaded and displayed on the display 150 depending on the moving direction and/or moving angle of the terminal 100. Movement of the terminal 100 will be described with reference to FIGS. 2 and 3.

FIGS. 2 and 3 illustrate changes in movement of a terminal according to an embodiment of the present invention.

Referring to FIG. 2, if the terminal 100 is moved in the directions of the X, −X, Y, and −Y axes with its current angle fixed, images output on the display 150 will be replaced by other images. If there is a plurality of images in the image folder, the images will be replaced and displayed in a previous/next image direction with respect to the current image depending on the moving direction of the terminal 100.

The images are replaced and displayed based on a moving direction or a tilt angle with respect to the X, Y, and Z axes as illustrated FIG. 3, in addition to the up/down and left/right directions as illustrated FIG. 2. Specifically, when the Y/−Y axis is set as the rotation axis, images are replaced and displayed as the terminal 100 rotates in a direction (i.e., back and forth) indicated by reference numeral 300. Similarly, when the Z/−Z axis is set as the rotation axis, images are replaced and displayed as the terminal 100 rotates in a direction indicated by reference numeral 310. In addition, when the X/−X axis is set as the rotation axis, images are replaced and displayed as the terminal 100 rotates in directions indicated by reference numerals 320 and 330. The images displayed on the display 150 are replaced in the order of previous/next images.

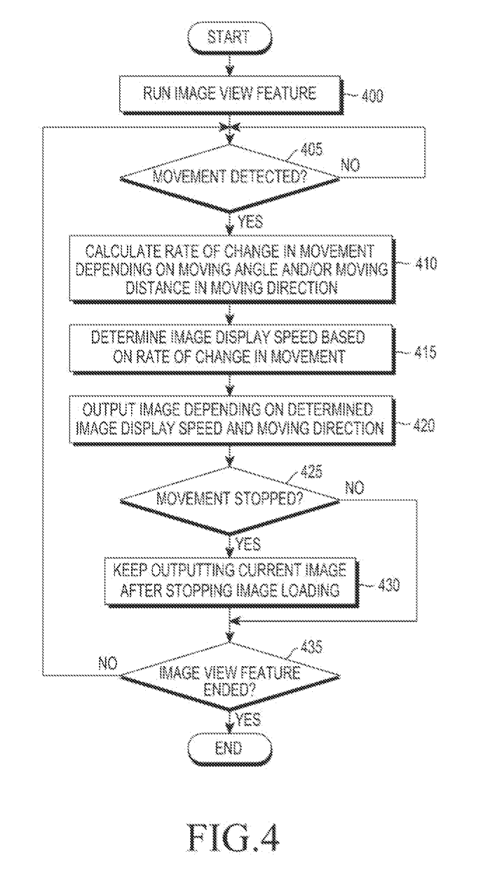

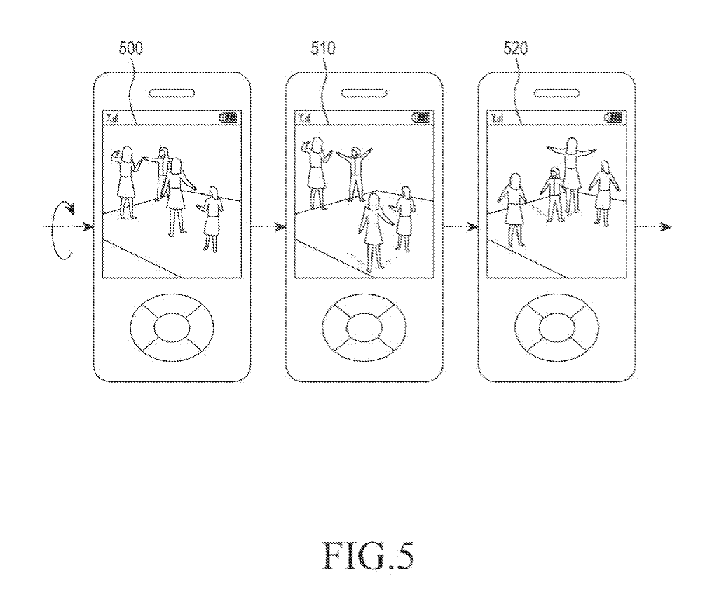

A process of outputting images depending on a change in movement in a terminal 100 according to an embodiment of the present invention will be described with reference to FIG. 4. A user selects images he or she desires to load consecutively from an image folder, and designate them as one or more groups in advance.

In step 400, upon receiving user input for viewing images, the terminal 100 runs an image view feature, displaying a screen on which the image view feature is running. The terminal 100 operates in a continuous image view mode when the image view feature runs, because the image view feature defined in the present invention is a continuous image view feature with which the user views one or more images in succession. If there is an image group registered by the user in advance, the terminal 100 causes the user to select his/her desired group on the screen where the image view feature is running. If any image group is selected, images contained in an image list and belonging to the selected group are loaded, the first loaded image is displayed on the display 150, and the other images will be set to be in a standby state.

While the first image is displayed on the display 150, it is then determined in step 405 whether movement of the terminal 100 is detected. Determining whether movement of the terminal 100 is detected, is initiated by the user pressing a touch icon or a input key for enabling the movement-based image view feature, or set as attributes of the image view feature in advance.

If movement of the terminal 100 is detected, a rate of change in movement is calculated depending on a moving angle and/or a moving distance in a moving direction in step 410. Specifically, if the user moves the terminal 100 up/down, left/right and back/forth as in FIGS. 2 and 3, or tilts the terminal 100 back and forth, the terminal calculates a moving direction, a moving distance in the moving direction, and a moving angle, and then calculates a rate of change in movement based thereon. An image display speed is then determined based on the rate of change in movement in step 415, and images in the image list are output depending on the determined image display speed and moving direction in step 420. Specifically, previous/next images of the current image on the screen are sequentially output depending on the moving direction, and the images are replaced depending on the determined image display speed. Vibrations are generated whenever images are replaced, to enable the user to feel the change in images.

For example, if the user tilts the terminal 100 around the reference axis serving as a rotation axis as shown in FIG. 5, a first image 500 on the screen is replaced and displayed in the order of a second image (the next image) 510 and a third image (the second next image) 520. As the tilt angle is greater, the switching speed from the first image 500 to the second and third images 510 and 520 is higher. When viewing the images 500, 510 and 520 in succession, the user may feel as if he or she is watching a video, because only objects move with the background standing still. However, images are replaced one by one in the order of the first image 500, the second image 510 and the third image 520, whenever the tilt angle exceeds a predetermined angle.

In step 425, it is determined whether the movement of the terminal 100 is stopped. If the movement is stopped, the terminal 100 stops the image loading and continues to output the current image in step 430. Specifically, if the user stops tilting the terminal 100 and then restores it to the initial horizontal state, or if the user stops the movement of the terminal 100 while the terminal 100 sequentially replaces and displays images depending on the rate in change of movement, then the images are no longer replaced and the image output at the time of the stopping continues to be output.

However, if the movement is not stopped, it is determined in step 435 whether the image view feature is ended. The terminal 100 returns to step 405 and repeats the above-described process unless the image view feature is ended.

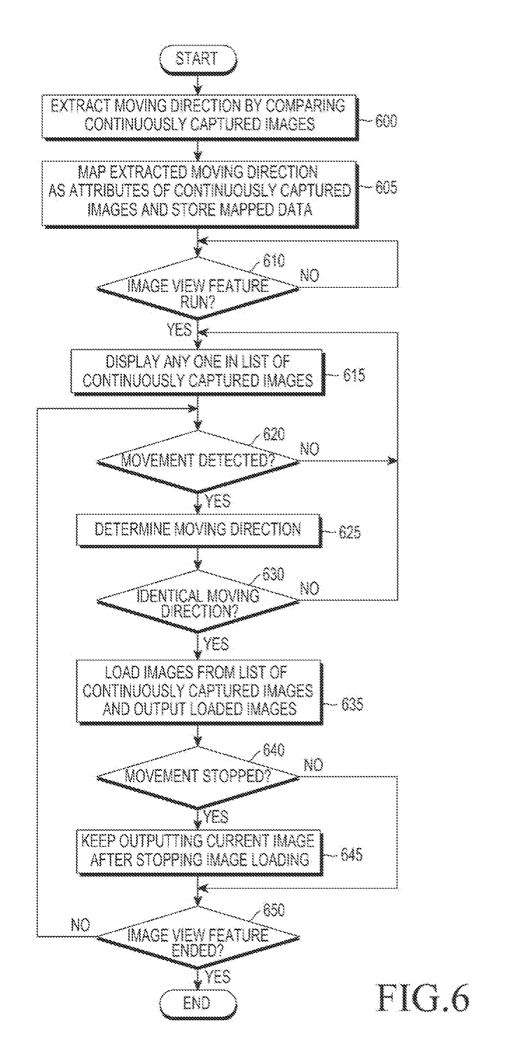

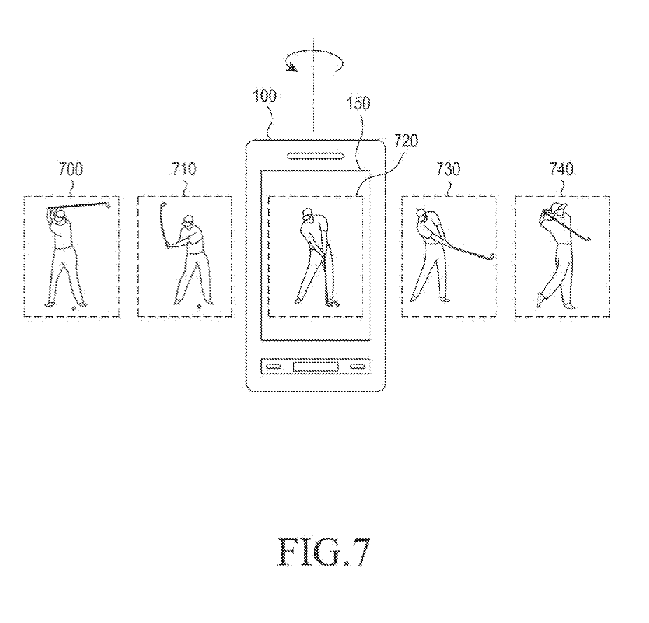

The process of outputting images based on a change in movement in a terminal 100 according to another embodiment of the present invention will be described with reference to FIG. 6. The process in FIG. 6 will be described with reference to FIG. 7. FIG. 7 illustrates a method for displaying consecutive images captured by a burst mode (or continuous shooting mode). Generally, when images are captured in burst mode, the background is stationary, but objects such as persons move in a certain direction. In the case of the continuously captured images, a moving direction of objects in the consecutive images such as a person is detected using an image recognition scheme. A detailed description of the image recognition scheme will be omitted herein.

In accordance with another embodiment of the present invention, an interface conforming to the moving direction characteristics of consecutive images is configured by automatically setting a moving direction of objects as a moving direction of the terminal 100.

Referring to FIG. 6, a moving direction of an object is extracted by comparing continuously captured images in step 600. An image recognition scheme is applied in order to extract a moving direction of an object in images. In step 605, the extracted moving direction is mapped as attributes of the continuously captured images and stored in the storage 120. If an image view feature runs in step 610, the terminal 100 then displays any one image in a list of continuously captured images in step 615. If movement of the terminal 100 is detected in step 620, a moving direction is determined in step 625. In step 630, it is determined whether the moving direction is identical to the moving direction mapped to the displayed image. If they are not identical, the terminal 100 returns to step 615, keeping the display of the current image.

However, if the moving direction is identical to the moving direction mapped to the displayed image, the terminal 100 loads images in the list of continuously captured images, and outputs the loaded images in step 635. For example, for consecutive images, the moving direction will be mapped to a left/right direction and stored in the storage 120 depending on the left/right swing action as in FIG. 7. Therefore, if the user moves the terminal 100 in the left/right direction, or tilts the terminal 100 around the rotation axis in the left/right direction, images will be continuously output in the order of a first image 700, a second image 710, a third image 720, a fourth image 730, and a fifth image 740. In the case in which the third image 720 is presently being displayed, if the user tilts the terminal 100 to the left, images are replaced and displayed in the order of the second image 710 and the first image 700. However, if the user tilts the terminal 100 to the right, images are replaced and displayed in the order of the fourth image 730 and the fifth image 740.

In step 640, it is determined whether the movement of the terminal 100 is stopped. If the movement is stopped, the terminal 100 stops the image loading and keeps the output of the current image in step 645. Unless the image view feature is ended in step 650, the terminal 100 then returns step 620 and repeats the above-described process.

Although in the foregoing description the moving direction is assumed to be designated using the image recognition scheme when consecutive images are stored, it will be understood by those of ordinary skill in the art that the moving direction may be set by the user, instead of using the image recognition scheme. Based on information about the total number of consecutive images captured in the burst mode and the number of images captured per second, the user may set the minimum tilt angle (or the minimum change in angle) for loading consecutive images.

As is apparent from the foregoing description, according to embodiments of the present invention, the user may easily control the image loading speed by simply moving the terminal, so the user may easily enjoy the image view feature, improving the user experience.

In addition, as the present invention provides an image view interface that is based on the intuitive and convenient movement of the terminal, the user may enjoy a plurality of images in succession more conveniently and easily when watching the continuously captured images.

Moreover, when viewing the photos in succession, the user may feel as if he is watching a video, because the user may adjust a playback speed of the continuously captured images.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. An apparatus for controlling image display based on movement of a terminal, the apparatus comprising:
a storage for storing one or more images;
a display for displaying an image in an image list stored in the storage;
a sensor unit for detecting movement of the terminal; and
a controller for sequentially replacing and outputting images in the image list on the display based on at least one of a moving direction and a moving angle of the terminal, upon detecting movement by the sensor unit.

2. The apparatus of claim 1, wherein the controller calculates a rate of change in movement based on at least one of a moving distance in the moving direction of the terminal and the moving angle of the terminal,
determines a loading speed of images based on the calculated rate of change in movement, the loading speed representing a speed at which a next image is loaded following the current image displayed on the display, and
sequentially replaces and outputs the images based on the determined loading speed.

3. The apparatus of claim 2, wherein the loading speed of images varies based on the rate of change in movement that is calculated based on the moving angle.

4. The apparatus of claim 1, wherein the moving direction of the terminal is at least one of up/down, left/right and back/forth directions in which the terminal is moved with respect to a user of the terminal, and directions in which the terminal is tilted around a reference axis.

5. The apparatus of claim 4, wherein the controller sequentially replaces and outputs images displayed on the display in a previous/next image direction based on the moving direction of the terminal.

6. The apparatus of claim 1, wherein the controller sequentially replaces and outputs the images when the moving angle of the terminal exceeds a predetermined angle.

7. The apparatus of claim 1, wherein the controller sequentially replaces and outputs the images at regular intervals while the moving angle of the terminal exceeds a predetermined angle for a predetermined period of time.

8. The apparatus of claim 1, wherein the controller keeps the output of the current image, if the movement of the terminal is stopped while sequentially replacing and outputting images in the image list.

9. The apparatus of claim 1, further comprising a vibrator for outputting vibrations when the images are sequentially replaced and output on the display.

10. The apparatus of claim 1, wherein the controller detects a moving direction of an object in consecutive images captured in a burst mode, and stores the consecutive images in the storage after mapping the detected moving direction to the consecutive images.

11. The apparatus of claim 10, wherein the controller sequentially replaces and outputs the consecutive images when the moving direction of the terminal is identical to the moving direction mapped to the consecutive images.

12. A method for controlling image display based on movement of a terminal in the terminal, the method comprising:
displaying any one image in an image list, when an image view feature runs;
detecting movement of the terminal; and
sequentially replacing and outputting images in the image list based on at least one of a moving direction and a moving angle of the terminal, upon detecting the movement of the terminal.

13. The method of claim 12, further comprising:
calculating a rate of change in movement based on at least one of a moving distance in the moving direction of the terminal and the moving angle of the terminal;
determining a loading speed of images in the image list based on the calculated rate of change in movement; and
sequentially replacing and outputting the images based on the determined loading speed.

14. The method of claim 13, wherein the loading speed of images is a speed at which a next image is loaded following the presently output image, and varies based on the rate of change in movement that is calculated based on the moving angle.

15. The method of claim 12, wherein the moving direction of the terminal is at least one of up/down, left/right and back/forth directions in which the terminal is moved with respect to a user of the terminal, and directions in which the terminal is tilted around a reference axis.

16. The method of claim 12, wherein sequentially replacing and outputting the images comprises sequentially replacing and outputting images in a previous/next image direction of the image being displayed, based on a moving direction of the terminal.

17. The method of claim 12, wherein sequentially replacing and outputting the images comprises sequentially replacing and outputting the images when the moving angle of the terminal exceeds a predetermined angle.

18. The method of claim 12, wherein sequentially replacing and outputting the images comprises sequentially replacing and outputting the images at regular intervals while the moving angle of the terminal exceeds a predetermined angle for a predetermined period of time.

19. The method of claim 12, further comprising:
determining whether the movement of the terminal is stopped, while sequentially replacing and outputting images in the image list; and
keeping the output of the current image, if the movement of the terminal is stopped.
